(19) United States
(12) Patent Application Publication
(10) Pub. No.: US 2009/0322699 A1
(43) Pub. Date: Dec. 31, 2009

(54) MULTIPLE INPUT DETECTION FOR RESISTIVE TOUCH PANEL

(75) Inventor: Per-Ragnar HANSSON, Stockholm (SE)

Correspondence Address: HARRITY & HARRITY, LLP, 11350 RANDOM HILLS ROAD, SUITE 600, FAIRFAX, VA, 22030, US

(73) Assignee: SONY ERICSSON MOBILE COMMUNICATIONS AB, Lund (SE)

(21) Appl. No.: 12/146,125

(22) Filed: Jun. 25, 2008

(51) Int. Cl. G06F 3/045

(52) U.S. Cl. 345/174

(57) ABSTRACT

A method performed by a device having a touch-sensitive panel includes detecting touch coordinates of a touch on the touch-sensitive panel and measuring a current though at least a portion of the touch-sensitive panel. The method further includes comparing the measured current with a threshold current and identifying the touch as a multiple touch based on the comparison of the measured current with a threshold current. The method may also include generating a command signal corresponding to the multiple touch.

### BACKGROUND

The proliferation of devices, such as handheld and portable devices, has grown tremendously within the past decade. A majority of these devices include some kind of display to provide a user with visual information. These devices may also include an input device, such as a keypad, touch screen, and/or one or more buttons to allow a user to enter some form of input. However, in some instances, the input device may have high costs or limit the space available for other components, such as the display. In other instances, the capabilities of the input device may be limited.

### SUMMARY

According to one aspect, a method performed by a device having a touch-sensitive panel may include detecting touch coordinates of a touch on the touch-sensitive panel; measuring a current though at least a portion of the touch-sensitive panel; comparing the measured current with a threshold current; identifying the touch as a multiple touch based on the comparison of the measured current with one or more particular current range; and generating a command signal corresponding to the multiple touch.

Additionally, the touch-sensitive display may include a resistive touch panel.

Additionally, identifying the touch may further include distinguishing the multiple touch from a single touch.

Additionally, identifying the touch may further include distinguishing between a two-point touch and a three-point touch.

Additionally, the one or more particular current range current may be based on the maximum expected current value for a single touch on the touch-sensitive panel at the detected touch coordinates.

Additionally, the one or more particular current range may be determined by empirical data or calculation.

Additionally, the multiple touch may be made with a combination of a body part and a pointing device.

According to another aspect, a device may include a display to display information; a touch-sensitive panel to identify touch coordinates of a touch on the touch-sensitive panel; an indicator to measure current through at least a portion of the touch-sensitive panel; processing logic to interpret the touch as one of a single touch or a dual touch based on the measured current; and processing logic to generate a command signal to alter the display based on the interpreted touch.

Additionally, the touch-sensitive pane may include a resistive touch panel.

Additionally, the device may further include a memory to store a threshold current for a particular set of touch coordinates.

Additionally, the threshold current may be based on the maximum expected current value for a single touch on the touch-sensitive panel at the particular set of touch coordinates.

Additionally, the threshold current is determined by empirical data or calculation.

Additionally, the touch-sensitive panel may be overlaid on the display.

Additionally, the device may further comprise a housing, where the touch-sensitive panel and the display are located on separate portions of the housing.

Additionally, the touch may be generated with a combination of a body part and a pointing device.

According to still another aspect, device may include a touch-sensitive panel to identify touch coordinates of a touch on the touch-sensitive panel; an indicator to measure current through at least a portion of the touch-sensitive panel; processing logic to interpret the touch as a multiple touch based on the measured current; and processing logic to generate a command signal corresponding to the multiple touch.

Additionally, the device may further include a memory, the memory storing a current value corresponding to a multiple touch at a particular touch coordinate, where the processing logic to interpret the touch compares the measured current to the current value corresponding to the multiple touch at the particular touch coordinate.

Additionally, the current value may be based on the maximum expected current for a single touch on the touch-sensitive panel at the touch coordinates.

Additionally, the memory may store a range of current values corresponding to a single touch, a two-point touch, and a three-point touch.

Additionally, the device may further comprise a display to display information, where the processing logic generates a command signal to alter the display based on the multiple touch.

### BRIEF DESCRIPTION OF THE DRAWINGS

The accompanying drawings, which are incorporated in and constitute a part of this specification, illustrate one or more embodiments described herein and, together with the description, explain these embodiments. In the drawings:

FIG. 1A is a diagram of an exemplary electronic device in which methods and systems described herein may be implemented;

FIG. 1B is an exploded view of an exemplary section of the electronic device of FIG. 1A;

FIG. 2 is a block diagram illustrating components of the electronic device of FIG. 1A according to an exemplary implementation;

FIG. 3 is an exemplary functional block diagram of the electronic device of FIG. 2;

FIGS. 4A-4C are schematics of an exemplary circuit for a touch panel according to implementations described herein;

FIG. 5A shows an exemplary single touch input on the surface of a touch panel;

FIG. 5B shows an exemplary dual touch input on the surface of a touch panel;

FIG. 6 is an exemplary table corresponding to the touch panel of FIGS. 5A and 5B.

FIG. 7 is a flow diagram illustrating exemplary operations associated with the exemplary electronic device of FIG. 1;

FIG. 8 is a flow diagram illustrating exemplary operations associated with identifying a type of input for the exemplary electronic device of FIG. 1; and

FIG. 9 is a diagram of another exemplary electronic device in which methods and systems described herein may be implemented.

### DETAILED DESCRIPTION

The following detailed description refers to the accompanying drawings. The same reference numbers in different drawings may identify the same or similar elements. Also, the following detailed description does not limit the invention.

### Overview

Resistive touch panels are generally one of the more affordable touch-sensitive input devices and may be used in many electronic devices, such as personal digital assistants (PDAs), smartphones, portable gaming devices, media player devices, camera devices, laptop computers, etc. A previous drawback with resistive touch panel technology is that generally these types of panels can only detect one touch input at a time. If a user touches on two points at the same time on a resistive touch panel, the detected coordinate will correspond to the average between the two points. Thus, processing software in the device cannot tell if a single or dual input was provided, since only coordinates from one position is given. Implementations described herein utilize touch-recognition techniques that distinguish between a single touch input and a simultaneous multiple touch input. Implementations of such distinctions may provide new user interface possibilities for devices with resistive touch panels.

The term “touch,” as used herein, may refer to a touch of an object or combination of objects, such as a body part (e.g., a finger) or a pointing device (e.g., a stylus, pen, etc.). A touch may be deemed to have occurred by virtue of the object activating an electrical connection within a touch-sensitive panel. A “single touch,” as used herein may refer to a touch by one object. A “multiple touch,” as used herein, may refer to a substantially simultaneous touch by two or more objects at different locations. The term “touch panel,” as used herein, may refer to a touch-sensitive panel that can detect the location of a touch within an area on the touch panel. The term “touch screen,” as used herein, may refer to a display with an integrated touch-sensitive panel.

In implementations described herein, a single touch or a multiple touch on a touch panel may be identified as a variable input signal depending on the location and type of touch. A single touch may be identified as a signal relative to the location of the touch by the user. A multiple touch may represent a different type of input signal than a single touch. Distinguishing a multiple touch from a single touch may be achieved by measuring variations in current through the touch panel during a multiple touch compared to a single touch. The multiple touch may not be location dependent, but may register as a distinct type of input signal from a single touch.

The multiple touch input signal may be utilized in a variety of different ways to facilitate a user interface for a device with, for example, a touch screen. For example, a single touch may be used select an on-screen option and a multiple touch may perform a zoom command. In another example, the distinction between a single and multiple touch may be used to differentiate between different command functions in a gaming environment. In still another example, the distinction between a single and multiple touch may emulate some operating system commands for a right side (e.g., single touch) and left side (e.g., multiple touch) of a two-button mouse.

### Exemplary Device

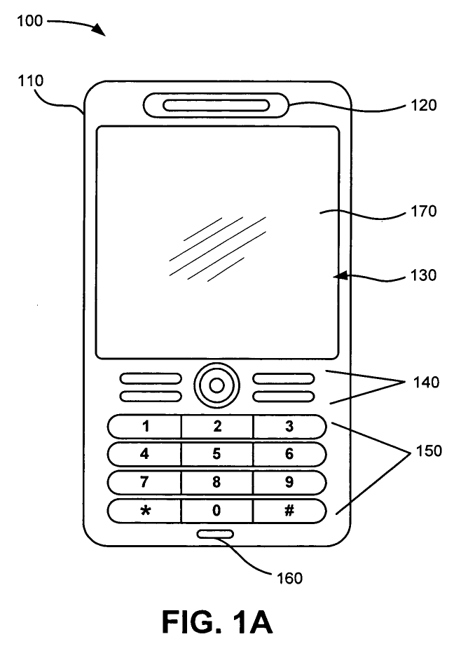

FIG. 1A is a diagram of an exemplary electronic device 100 in which methods and systems described herein may be implemented. Implementations are described herein in the context of an electronic device having a touch screen. As used herein, the term “electronic device” may include a cellular radiotelephone; a Personal Communications System (PCS) terminal that may combine a cellular radiotelephone with data processing, facsimile and data communications capabilities; a PDA that can include a radiotelephone, pager, Internet/Intranet access, Web browser, organizer, calendar and/or a global positioning system (GPS) receiver; a gaming device; a media player device; a digital camera; a laptop or palmtop computer; or any other appliance that includes a touch-pad or touch-screen interface. Electronic device 100 may also include communication, media playing, recording, and storing capabilities.

Referring to FIG. 1A, electronic device 100 may include a housing 110, a speaker 120, a display 130, control buttons 140, a keypad 150, a microphone 160, and a touch panel 170. Housing 110 may protect the components of electronic device 100 from outside elements. Speaker 120 may provide audible information to a user of electronic device 100. Speaker 120 may include any component capable of transducing an electrical signal to a corresponding sound wave. For example, a user may listen to a voice or music through speaker 120.

Display 130 may provide visual information to the user and serve—in conjunction with touch panel 170—as a user interface to detect user input. For example, display 130 may provide information and menu controls regarding incoming or outgoing telephone calls and/or incoming or outgoing electronic mail (e-mail), instant messages, Internet web pages, short message service (SMS) messages, etc. Display 130 may further display information and controls regarding various applications executed by electronic device 100, such as a phone book/contact list program, a calendar, an organizer application, image manipulation applications, navigation/mapping applications, as well as other applications. For example, display 130 may present information and images associated with application menus that can be selected using multiple types of input commands. Display 130 may also display images associated with a camera, including pictures or videos taken by the camera and/or received by electronic device 100. Display 130 may also display video games being played by a user, downloaded content (e.g., news, images, or other information), etc.

Display 130 may include a device that can display signals generated by electronic device 100 as text or images on a screen (e.g., a liquid crystal display (LCD), cathode ray tube (CRT) display, organic light-emitting diode (OLED) display, surface-conduction eletro-emitter display (SED), plasma display, field emission display (FED), bistable display, etc.). In certain implementations, display 130 may provide a high-resolution, active-matrix presentation suitable for the wide variety of applications and features associated with typical mobile devices.

Control buttons 140 may also be included to permit the user to interact with electronic device 100 to cause electronic device 100 to perform one or more operations, such as place a telephone call, play various media, access an application, etc. For example, control buttons 140 may include a dial button, hang up button, play button, etc. One of control buttons 140 may be a menu button that permits the user to view various settings on display 130. In one implementation, control keys 140 may be pushbuttons.

Keypad 150 may also be included to provide input to electronic device 100. Keypad 150 may include a standard telephone keypad. Keys on keypad 150 may perform multiple functions depending upon a particular application selected by the user. In one implementation, each key of keypad 150 may be, for example, a pushbutton. A user may utilize keypad 150 for entering information, such as text or a phone number, or activating a special function. Alternatively, keypad 150 may take the form of a keyboard that may facilitate the entry of alphanumeric text.

Microphone 160 may receive audible information from the user. Microphone 160 may include any component capable of transducing air pressure waves to a corresponding electrical signal.

As shown in FIG. 1A, touch panel 170 may be integrated with and/or overlaid on display 130 to form a touch screen or a panel-enabled display that may function as a user input interface. For example, touch panel 170 may include a pressure-sensitive (e.g., resistive) touch panel that allows display 130 to be used as an input device. Generally, touch panel 170 may include any kind of technology that provides the ability to distinguish between changing current as one or more objects are depressed on the surface of touch panel 170. Touch panel 170 may include the ability to identify movement of an object as it moves along the surface of touch panel 170.

In other implementations, touch panel 170 may be smaller or larger than display 130. In still other implementations, touch panel 170 may not overlap the area of display 130, but instead may be located elsewhere on the surface of housing 110. In other embodiments, touch panel 170 may be divided into multiple touch panels, such as touch panels in strips around the edge of display 130. In still other implementations, front touch panel may cover display 130 and wrap around to at least a portion of one other surface of housing 110.

FIG. 1B is an exploded view of an exemplary section of electronic device 100, including touch panel 170 and display 130. In one embodiment, touch panel 170 may include a resistive touch overlay having a top layer 172 and a bottom layer 174 separated by spaced insulators 176. The inside surface of each of the two layers 172 and 174 may be coated with a material—such as a transparent metal oxide coating (e.g., indium tin oxide)—that facilitates a gradient across the top and bottom layer when voltage is applied. Touching (e.g., pressing down) on top layer 172 may create electrical contact between top layer 172 and bottom layer 174, producing a closed circuit between top layer 172 and bottom layer 174 and allowing identification of, for example, X and Y touch coordinates. The touch coordinates may be associated with a portion of display 130 having corresponding coordinates.

The components described above with respect to electronic device 100 are not limited to those described herein. Other components, such as connectivity ports, memory slots, and/or additional speakers, may be located on electronic device 100, including, for example, on a rear or side panel of housing 110.

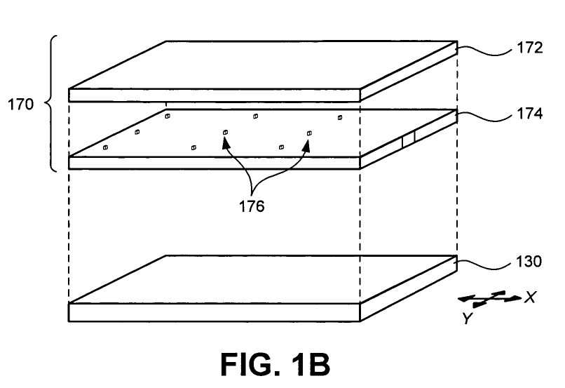

FIG. 2 is a block diagram illustrating components of the electronic device 100 according to an exemplary implementation. Electronic device 100 may include bus 210, processing logic 220, memory 230, touch panel 170, touch panel controller 240, input device 250, and power supply 260. Electronic device 100 may be configured in a number of other ways and may include other or different components. For example, electronic device 100 may include one or more output devices, modulators, demodulators, encoders, and/or decoders for processing data.

Bus 210 may permit communication among the components of electronic device 100. Processing logic 220 may include a processor, a microprocessor, an application specific integrated circuit (ASIC), a field programmable gate array (FPGA), or the like. Processing logic 220 may execute software instructions/programs or data structures to control operation of electronic device 100.

Memory 230 may include a random access memory (RAM) or another type of dynamic storage device that may store information and instructions for execution by processing logic 220; a read only memory (ROM) or another type of static storage device that may store static information and instructions for use by processing logic 220; a flash memory (e.g., an electrically erasable programmable read only memory (EEPROM)) device for storing information and instructions; and/or some other type of magnetic or optical recording medium and its corresponding drive. Memory 230 may also be used to store temporary variables or other intermediate information during execution of instructions by processing logic 220. Instructions used by processing logic 220 may also, or alternatively, be stored in another type of computer-readable medium accessible by processing logic 220. A computer-readable medium may include one or more physical or logical memory devices.

Touch panel 170 may accept touches from a user that can be converted to signals used by electronic device 100. Touch coordinates on and/or measurements of current through touch panel 170 may be communicated to touch panel controller 240. Data from touch panel controller 240 may eventually be passed on to processing logic 220 for processing to, for example, associate the touch coordinates and/or current measurements with information displayed on display 130.

Input device 250 may include one or more mechanisms in addition to touch panel 170 that permit a user to input information to electronic device 100, such as microphone 160, keypad 150, control buttons 140, a keyboard, a gesture-based device, an optical character recognition (OCR) based device, a joystick, a virtual keyboard, a speech-to-text engine, a mouse, a pen, voice recognition and/or biometric mechanisms, etc. In one implementation, input device 250 may also be used to activate and/or deactivate touch panel 170.

Power supply 260 may include one or more batteries or another power source used to supply power to components of electronic device 100. Power supply 260 may also include control logic to control application of power from power supply 260 to one or more components of electronic device 100.

Electronic device 100 may provide a platform for a user to make and receive telephone calls; send and receive electronic mail and/or text messages; play various media, such as music files, video files, multi-media files, and games; and execute various other applications. Electronic device 100 may perform these operations in response to processing logic 220 executing sequences of instructions contained in a computer-readable medium, such as memory 230. Such instructions may be read into memory 230 from another computer-readable medium. In alternative embodiments, hard-wired circuitry may be used in place of or in combination with software instructions to implement operations described herein. Thus, implementations described herein are not limited to any specific combination of hardware circuitry and software.

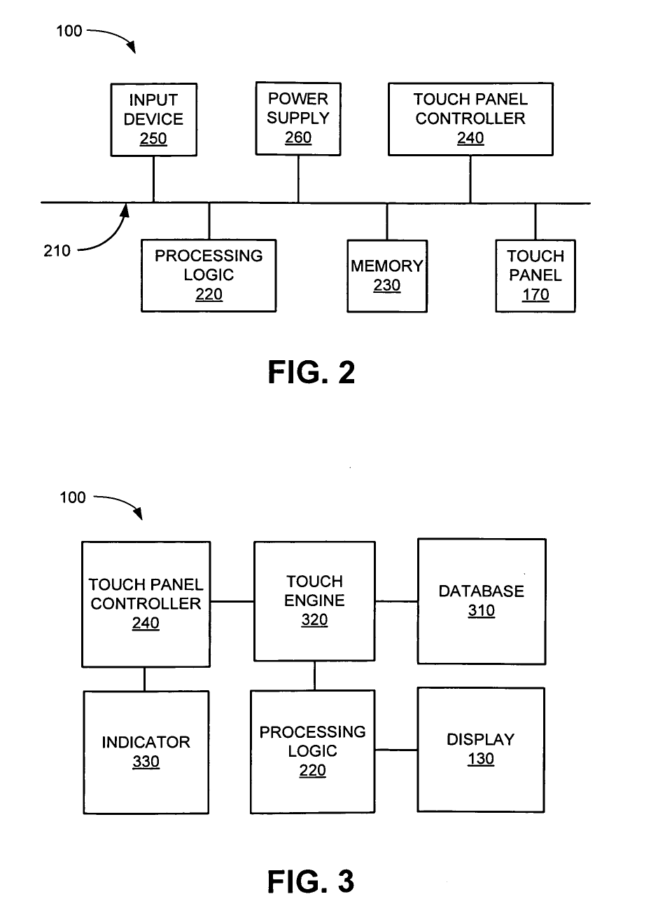

FIG. 3 is a functional block diagram of exemplary components that may be included in electronic device 100. As shown, electronic device 100 may include touch panel controller 240, database 310, touch engine 320, indicator 330, processing logic 220, and display 130. In other implementations, electronic device 100 may include fewer, additional, or different types of functional components than those illustrated in FIG. 3.

Touch panel controller 240 may identify touch coordinates on touch panel 170 and/or electric current through portions of touch panel 170. The touch coordinates may be determined based on voltage measurements from indicator 330. Current measurements for the touch coordinates may also be provided to touch panel controller from indicator 330. Touch panel controller 240 may supply the touch coordinates and current measurements to touch engine 320 to associate the touch coordinates and current measurement with, for example, a single touch or a multiple touch. The current measurement associated with a user input may be compared against particular set of threshold measurements to distinguish between a single touch and a multiple touch.

Database 310 may be included in memory 230 (FIG. 2) and act as an information repository for touch engine 320. For example, touch engine 320 may associate current measurements on touch panel 170 with particular current level thresholds stored in database 310.

Touch engine 320 may include hardware and/or software for processing signals that are received at touch panel controller 240. More specifically, touch engine 320 may use the signal received from touch panel controller 240 to detect touches on touch panel 170 and current measurements associated with the touches to differentiate between types of touches (e.g., single touch or multiple touch). The touch detection, the current measurement, and (in the case of a single touch) the touch location may be used to provide a variety of user inputs to electronic device 100.

Indicator 330 may include one or more measuring instruments to measure both the voltage and the electric current in a circuit. For example, indicator 330 may include a volt-amp meter measuring instantaneous voltage values of voltage and substantially simultaneous instantaneous values of current of an electrical circuit created by a touch on a touch panel. Voltage measurements may be used to correlate the distance from a voltage source (e.g., power supply 260) to the location of contact between the upper and lower layers of the touch panel. Current measurements may be used to identify current flow corresponding to the registered location of contact on the touch panel.

Processing logic 220 may implement changes in display 130 based on signals from touch engine 320. For example, in response to signals that are received at touch panel controller 240, touch engine 320 may cause processing logic 220 to display a menu that is associated with an item previously displayed on the touch screen at one of the touch coordinates. In another example, touch engine 320 may cause processing logic 220 to reduce or enlarge the image on display 130 (e.g., zoom in or zoom out).

### Exemplary Implementation of Embedded Processes

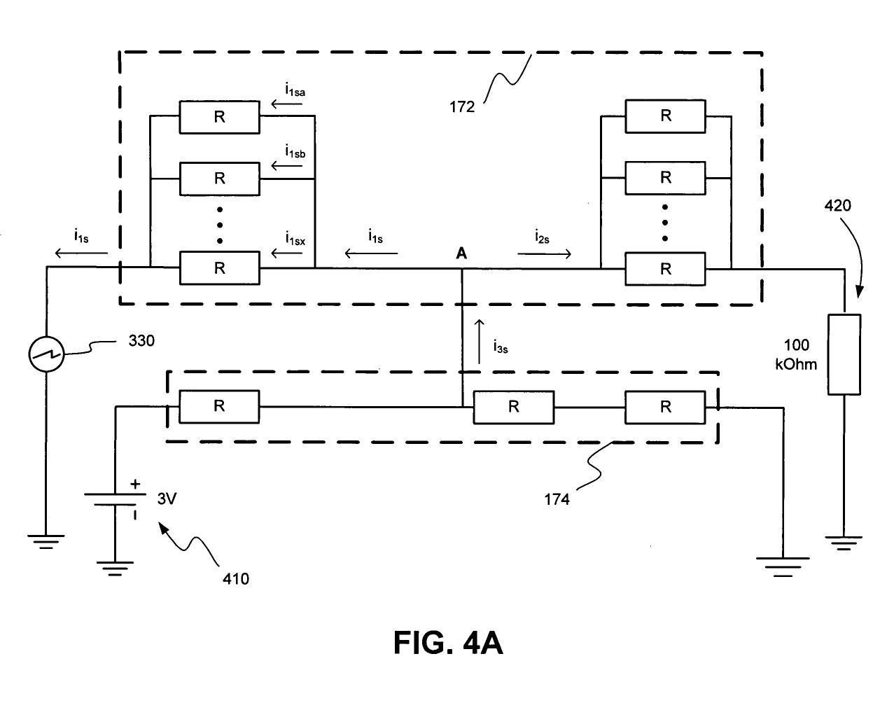

FIGS. 4A-4C provide exemplary schematics of a simplified circuit for a touch panel according to implementations described herein. FIG. 4A provides a circuit for a touch panel receiving a single touch. FIG. 4B provides a circuit for a touch panel receiving a multiple touch, and, more specifically, a dual (i.e., two-point) touch. FIG. 4C provides an equivalent circuit for a touch panel receiving the dual touch represented in FIG. 4B.

Referring collectively to FIGS. 4A-4C, top layer 172 and bottom layer 174 are conductive layers with surface resistance throughout each layer. Bottom layer 174 may be operatively connected to power source 410, which may be, for example, a 3 volt battery. Top layer 172 may be operatively connected to a resistor 420 at one end and, at the other end, to indicator 330 to measure current and voltage. A current can flow through top layer 172 and bottom layer 174 when the user touches top layer 172 at one or more locations, causing an electrical connection between top layer 172 and bottom layer 174. One flow of current may flow through top layer 172 and one flow of current may flow through bottom layer 174. In the exemplary arrangement of FIGS. 4A-4C, measurements (e.g., at indicator 330) may be taken for top layer 172, and, thus, only current flow through top layer 172 is further discussed herein.

Referring particularly to FIG. 4A, when the user pushes at point A (e.g., a single touch on the surface of the touch panel), current i₃ₛ can flow from lower layer 174 to upper layer 172. Current i₃ₛ may be divided into current components i₁ₛ and i₂ₛ. Because resistor 420—a 100 kOhm resistor—is coupled to ground, current i₂ₛ is very small and can be neglected (i.e., i₂ₛ≈0). Since the conductive portion of top layer 172 may be essentially a two-dimensional surface, the current i₁ₛ may be considered to be divided into a number of parallel currents i₁ₛₐ, i_{1sb} . . . i₁ₛₓ. i₁ₛ, and thus, can be considered to be sum of currents i₁ₛₐ, i_{1sb} . . . i₁ₛₓ. Current i₁ₛ may be measured at indicator 330. Also, the voltage that is generated when the user touches at point A will correspond to a coordinate (such as an X, Y coordinate) at point A.

Referring to FIG. 4B, when the user touches simultaneously at point B and point C (e.g., a dual touch), a current can flow from lower layer 174 to upper layer 172 at each touch point. The voltage that is generated when the user pushes point B and point C can correspond to a different coordinate (e.g., point D of FIG. 4C) at a point between B and C. Also, the resistance(s) R_{BC} between B and C can be represented by an effective resistance (e.g., R_{eff} of FIG. 4C). Thus, the simultaneous touch at point B and point C shown in FIG. 4B may be equivalently represented in FIG. 4C.

Referring to FIG. 4C, current i through R_{eff} can be divided into i₁ and i₂ at point D. Similar to the discussion above with respect to the current i₂ₛ of FIG. 4A, the current i₂ can again be neglected (i.e., i₂≈0). Also, similar to the current i₁ₛ, current i₁ can be considered to be divided over a number of parallel currents i₁ₐ, i_{1b} . . . i₁ₓ. I1, thus, can be considered to be the sum of currents i₁ₐ, i_{1b} . . . i₁ₓ Current i₁ can be measured at indicator 330. Also, the voltage that is generated when the user touches at points B and C may correspond to a coordinate at point D.

A single touch and a dual touch may both allow voltage and current to be measured. Furthermore, for each coordinate that can be registered either by single touch or a dual touch, a voltage level and two different currents can exist. Assume, in the example of FIG. 4A-4C, that point A (FIG. 4A) and point D (FIG. 4C) represent the same coordinate. Although the voltage readings will be the same, current i₁ₛ of FIG. 4A will not equal current i₁ of FIG. 4C due at least in part to the existence of R_{eff} for the dual touch of FIG. 4C. Generally, current i₁ₛ may be less than current i₁.

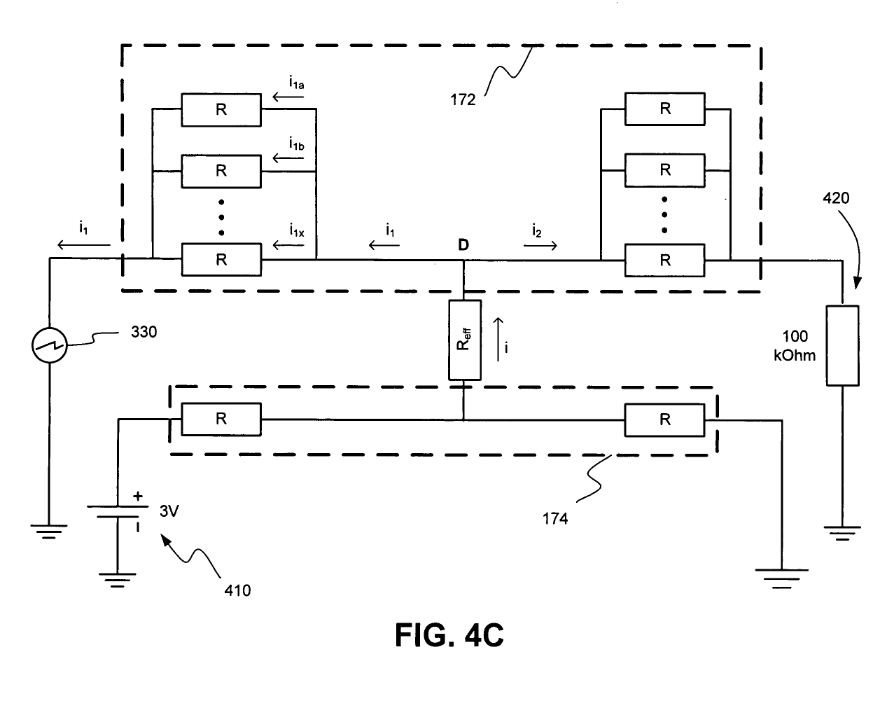

The difference in measured current for the same measured voltage coordinate may be used to determine if a single touch or a dual touch has occurred. More particularly, a single threshold current (e.g., iₜₕ_{_{—}}ₛ) can be defined for each coordinate, so that if the measured current (e.g., iₘₑₐₛ) is greater than the threshold current, then a dual touch may be registered (e.g., if iₘₑₐₛ>iₜₕ_{_{—}}ₛ then dual touch). Conversely, if the measured current is less than or equal to the threshold current, then a single touch may be registered at the coordinated indicated by the voltage measurement (e.g., if iₘₑₐₛ≦iₜₕ_{_{—}}ₛ, then single touch). The threshold currents iₜₕ_{_{—}}ₛ can be stored as a look-up table, such as the exemplary table described herein with respect to FIG. 6. The threshold values for each input coordinate/position may be found, for example, by empirical data or may be calculated with an electrical model.

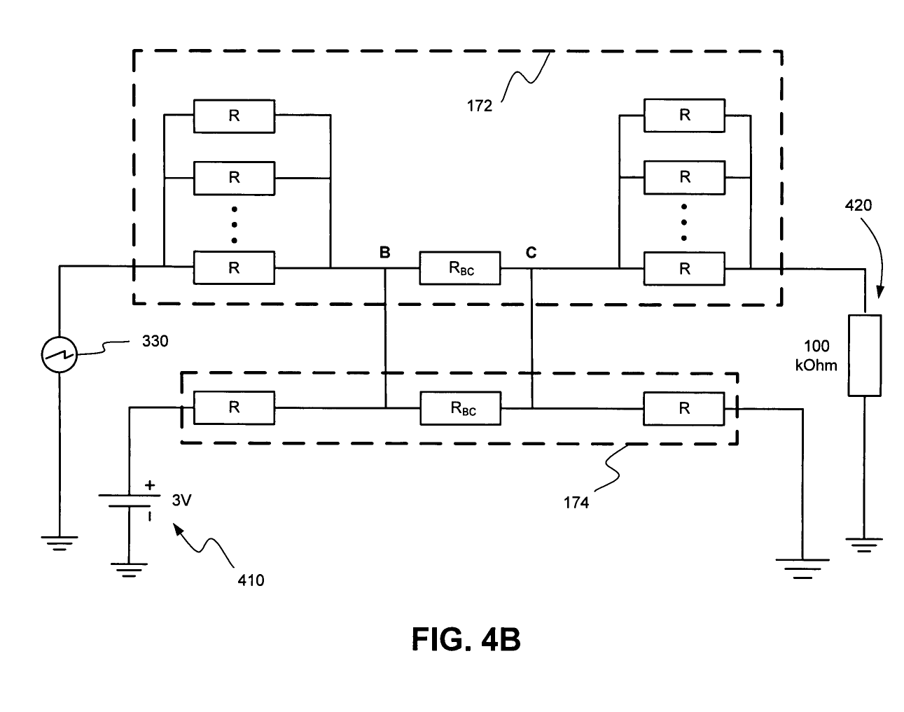

FIG. 5A shows an exemplary single touch input on the surface of a touch panel, and FIG. 5B shows an exemplary dual touch input on the surface of a touch panel. In both FIG. 5A and FIG. 5B, a representative pattern of coordinates 510 is shown with coordinates A, B, C, D, E, F, G, H, and I. Coordinates 510 may represent, for example, a simple touch panel with nine coordinates or a high resolution touch panel divided into nine zones. For each coordinate A through I a certain measured voltage can be used to identify the coordinate and a measured current can be used to determine if a single touch or dual touch was made. While a set of nine coordinates are shown in FIGS. 5A and 5B, any number of coordinates may be used with the systems and methods described herein.

In FIG. 5A, the user may apply a single touch 520 in the vicinity of coordinate E, and an input 525 may be registered in the vicinity of coordinate E based on the voltage measurement in the touch panel. At the same time, a current (e.g., i_{E}) from the single input may be measured, as described above with respect to FIG. 4A.

In FIG. 5B, the user may apply a dual touch 530, 531. Touch 530 may be applied in the vicinity of coordinate D, and touch 531 may be applied in the vicinity of coordinate F. Similar to FIG. 5A, an input 525 may be registered in the vicinity of coordinate E based on the voltage in the touch panel. A current (e.g., i_{DF}) from the single input may also be measured, as described above with respect to FIGS. 4B and 4C. Because current i_{E} and current i_{DF} are not equal, the different current measurements may be used to distinguish a single touch from a dual touch. For example, current i_{E} and current i_{DF} may be compared against a threshold current iₜₕ_{_{—}}ₛ.

FIG. 6 is an exemplary table 600 corresponding to the touch panel of FIGS. 5A and 5B. The table includes voltages for X-coordinates, voltages for Y-coordinates, positions, currents for single touch, and threshold currents for dual touch. The table may be stored, for example, in database 310 (FIG. 3) or another memory component of electronic device 100.

Table 600 may be used to look up current values for a registered voltage coordinate. As an example, refer particularly to position E in table 600 and the touch panel surface of FIGS. 5A and 5B. The measured voltage for both a single touch at position E and a dual touch at positions D and F will be X,Y=2,2. Both the single touch and the dual touch inputs occur on row Y=2. The single touch inputs occur on row X=2; and the dual touch is on X=1 and X=3, providing an average X-coordinate of X=2. Thus, the same E position may be registered for either the dual touch or single touch based on voltage measurements. A measurement of the current associated with the E position input may be compared against a threshold value, which is greater than 1.5 mA for position E. A measured current of less than or equal to 1.5 mA may be registered as a single touch. A measured current of greater than 1.5 mA may be registered as a dual touch.

While exemplary table 600 provides currents for single touches and threshold currents for dual touches, in another implementation table 600 may further include measurements to distinguish between two touches and three or more touches. Thus, the concepts described above to distinguish the currents between a single and dual touch, may be extended to distinguish between two touches and three or more touches.

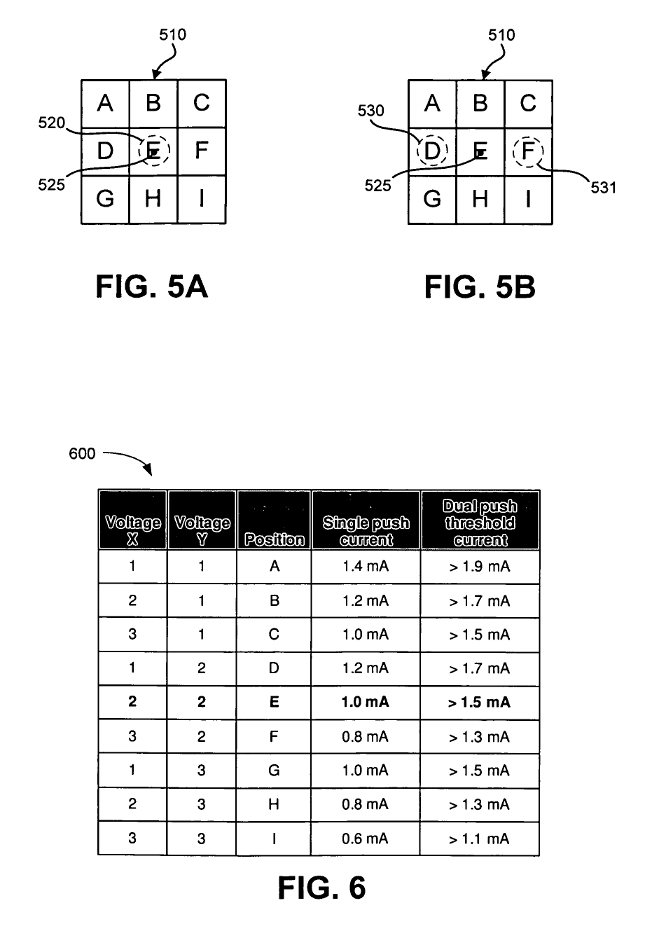

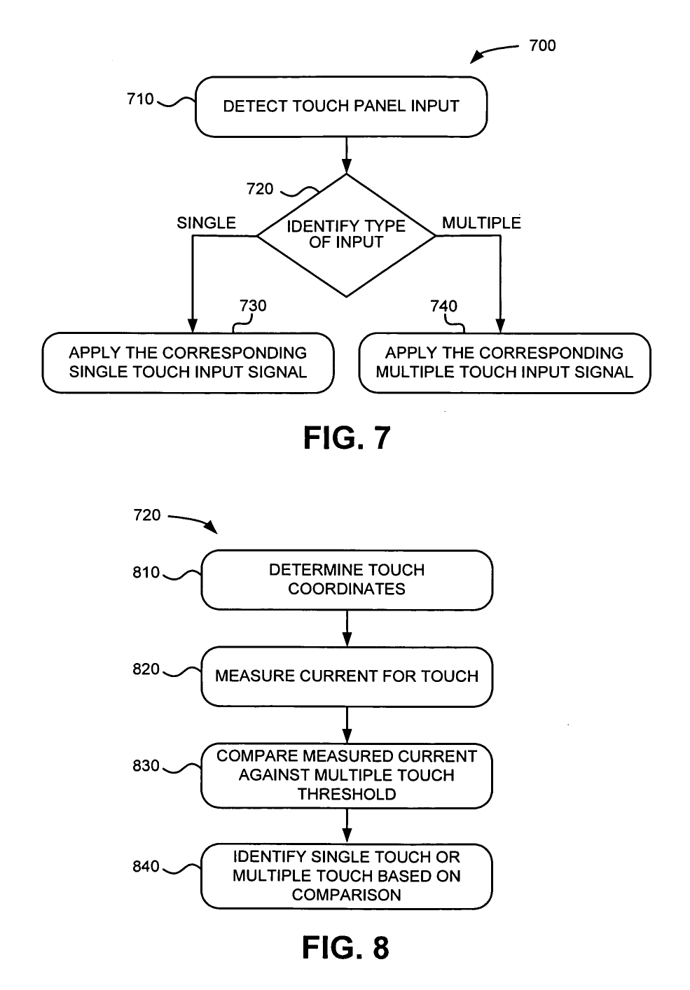

FIG. 7 is a flow diagram 700 illustrating exemplary operations associated with, for example, electronic device 100 for detection of an input type. An input to the touch panel may be detected (block 710). For example, electronic device 100 may detect a touch from a user. The type of input may be identified (block 720). For example, electronic device 100 may identify the type of input (e.g., a single touch or a multiple touch) to determine the appropriate signal to send from processing logic 220 to other system components. If the touch input generates a current equal to or below a particular threshold (as described in more detail with respect to FIG. 8), a single touch input may be identified. Thus, the input signal corresponding to a single touch may be applied (block 730). For example, electronic device 100 may apply a corresponding input signal related to the location of the single touch. If the touch input generates a current above a particular threshold (as described in more detail with respect to 8), a multiple touch input may be identified. Thus, the input signal corresponding to a multiple touch may be applied (block 740). For example, electronic device 100 may apply a corresponding input signal not related to the particular location of the registered coordinates.

FIG. 8 is a flow diagram illustrating exemplary operations associated with electronic device 100 for identification of an input type, as referred to in block 720 of FIG. 7. The touch coordinates are determined (block 810). For example, the touch panel controller 240 or other component of electronic device 100 may use voltage measurements from the touch panel to register a position of a user's touch. The current for the touch may be measured (block 820). For example, the touch panel controller or other component of electronic device 100 may measure the current through a layer of the touch panel when the touch occurs. The measured current may be compared against a multiple touch threshold (block 830). For example, the touch engine or other component of electronic device 100 may compare the measured current against a multiple touch threshold value for the particular coordinates. The multiple touch threshold value may be stored as part of a look-up table, such as table 600, in device 100. A single touch or multiple touch may be identified based on the threshold comparison (block 840). For example, the touch engine or other component of electronic device 100 may determine that the measured current is below the multiple touch threshold value and identify a single touch. Alternatively, the touch engine or other component of electronic device 100 may determine that the measured current is above the multiple touch threshold value and identify a multiple touch.

### Exemplary Device

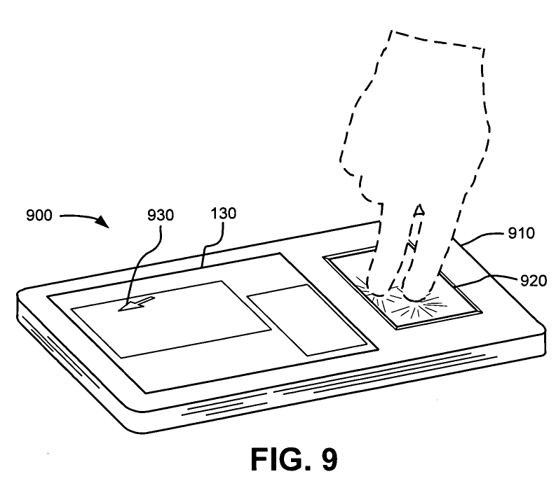

FIG. 9 is a diagram of exemplary electronic device 900 in which methods and systems described herein may be implemented. Electronic device 900 may include housing 910, display 130, and touch pad 920. Other components, such as control buttons, a keypad, a microphone, a camera, connectivity ports, memory slots, and/or additional speakers, may be located on electronic device 900, including, for example, on a rear or side panel of housing 910. FIG. 9 illustrates touch panel 920 being separately located from display 130 on housing 910. Touch panel 920 may include any resistive touch panel technology or other technology providing the ability to measure current as the touch panel 920 registers a set of touch coordinates. User input on touch panel 920 may be associated with display 130 by, for example, movement and location of cursor 930. User input on touch panel 920 may be in the form of the touch of nearly any object, such as a body part (e.g., a finger, as shown), a pointing device (e.g., a stylus, pen, etc.), or a combination of devices.

Touch panel 920 may be operatively connected with display 130. For example, touch panel 920 may include a pressure-sensitive (e.g., resistive) touch panel that allows display 130 to be used as an input device. Touch panel 920 may include the ability to identify movement of an object as it moves on the surface of touch panel 920. As described above with respect to, for example, FIGS. 5A and 5B, a touch may be identified as a single touch or a multiple touch (with a dual touch being shown in FIG. 9). In the implementation of FIG. 9, the multiple touch may correspond to the general presentation of information display 130 (e.g., a zoom command, page down, or toggle) and not necessarily be related to the position of the cursor 930 on display 130.

### CONCLUSION

Implementations described herein may include a touch-sensitive interface for an electronic device that distinguishes between different kinds of touches, referred to herein as a single touch or multiple touch. In other implementations, the systems and methods described herein may further distinguish between different kinds of multiple touches (e.g., between a two-point touch and a three-point touch). By distinguishing between the different kinds of touches, different forms of user input may be supplied using a single touch-sensitive interface.

The foregoing description of the embodiments described herein provides illustration and description, but is not intended to be exhaustive or to limit the invention to the precise form disclosed. Modifications and variations are possible in light of the above teachings or may be acquired from practice of the invention.

For example, implementations have been mainly described in the context of a mobile electronic device. These implementations, however, may be used with any type of device using a touch-sensitive display. In certain implementations, touch recognition systems may be located behind another surface so that user input may occur on a surface other than that of the touch recognition system. Furthermore, in some implementations, multiple types of touch panel technology may be used within a single device.

As another example, while the examples above primarily describe distinctions between a single touch and a dual touch. In other implementations, the systems and methods described herein may be used to distinguish between types of multiple touches, such as a two-point touch and a three-point touch. Thus, the concepts described above to distinguish the currents between a single and dual touch, may be extended to distinguish among two touches, three touches and more than three touches.

Further, while a series of blocks has been described with respect to FIGS. 7 and 8, the order of the blocks may be varied in other implementations. Moreover, non-dependent blocks may be performed in parallel.

Aspects described herein may be implemented in methods and/or computer program products. Accordingly, aspects may be embodied in hardware and/or in software (including firmware, resident software, micro-code, etc.). Furthermore, aspects described herein may take the form of a computer program product on a computer-usable or computer-readable storage medium having computer-usable or computer-readable program code embodied in the medium for use by or in connection with an instruction execution system. The actual software code or specialized control hardware used to implement these aspects is not limiting. Thus, the operation and behavior of the aspects were described without reference to the specific software code—it being understood that software and control hardware could be designed to implement the aspects based on the description herein.

Further, certain aspects described herein may be implemented as “logic” that performs one or more functions. This logic may include hardware—such as a processor, microprocessor, an application specific integrated circuit or a field programmable gate array—or a combination of hardware and software.

It should be emphasized that the term “comprises/comprising” when used in this specification is taken to specify the presence of stated features, integers, steps, or components, but does not preclude the presence or addition of one or more other features, integers, steps, components, or groups thereof.

Even though particular combinations of features are recited in the claims and/or disclosed in the specification, these combinations are not intended to limit the invention. In fact, many of these features may be combined in ways not specifically recited in the claims and/or disclosed in the specification.

No element, act, or instruction used in the description of the present application should be construed as critical or essential to the invention unless explicitly described as such. Also, as used herein, the article “a” is intended to include one or more items. Where only one item is intended, the term “one” or similar language is used. Further, the phrase “based on,” as used herein is intended to mean “based, at least in part, on” unless explicitly stated otherwise.

The scope of the invention is defined by the claims and their equivalents.

What is claimed is:

1. A method performed by a device having a touch-sensitive panel, the method comprising:
detecting touch coordinates of a touch on the touch-sensitive panel;
measuring a current though at least a portion of the touch-sensitive panel;
comparing the measured current with a threshold current;
identifying the touch as a multiple touch based on the comparison of the measured current with one or more particular current range; and
generating a command signal corresponding to the multiple touch.

2. The method of claim 1, where the touch-sensitive display includes a resistive touch panel.

3. The method of claim 1, where identifying the touch further comprises distinguishing the multiple touch from a single touch.

4. The method of claim 1, where identifying the touch further comprises distinguishing between a two-point touch and a three-point touch.

5. The method of claim 1, where the one or more particular current range is based on the maximum expected current value for a single touch on the touch-sensitive panel at the detected touch coordinates.

6. The method of claim 5, further comprising:
determining the one or more particular current range by empirical data or by calculation.

7. The method of claim 1, where the multiple touch is made with a combination of a body part and a pointing device.

8. A device comprising:
a display to display information;
a touch-sensitive panel to identify touch coordinates of a touch on the touch-sensitive panel;
an indicator to measure current through at least a portion of the touch-sensitive panel;
processing logic to interpret the touch as one of a single touch or a dual touch based on the measured current; and
processing logic to generate a command signal to alter the display based on the interpreted touch.

9. The device of claim 8, where the touch-sensitive panel includes a resistive touch panel.

10. The device of claim 8, further comprising:
a memory to store a threshold current for a particular set of touch coordinates.

11. The device of claim 10, where the threshold current is based on the maximum expected current value for a single touch on the touch-sensitive panel at the particular set of touch coordinates.

12. The device of claim 11, where the threshold current is determined by empirical data or calculation.

13. The device of claim 8, where the touch-sensitive panel is overlaid on the display.

14. The device of claim 8, further comprising:
a housing, where the touch-sensitive panel and the display are located on separate portions of the housing.

15. The device of claim 8, where the touch is generated with a combination of a body part and a pointing device.

16. A device comprising:
a touch-sensitive panel to identify touch coordinates of a touch on the touch-sensitive panel;
an indicator to measure current through at least a portion of the touch-sensitive panel;
processing logic to interpret the touch as a multiple touch based on the measured current; and
processing logic to generate a command signal corresponding to the multiple touch.

17. The device of claim 16, further comprising:
a memory, the memory storing a current value corresponding to a multiple touch at a particular touch coordinate, where the processing logic to interpret the touch compares the measured current to the current value corresponding to the multiple touch at the particular touch coordinate.

18. The device of claim 17, where the current value is based on the maximum expected current for a single touch on the touch-sensitive panel at the touch coordinates.

19. The device of claim 17, where the memory stores a range of current values corresponding to a single touch, a two-point touch, and a three-point touch.

20. The device of claim 16, further comprising:
a display to display information, where the processing logic generates a command signal to alter the display based on the multiple touch.
